(19) United States
(12) Patent Application Publication
(10) Pub. No.: US 2002/0146272 A1
(43) Pub. Date: Oct. 10, 2002

(54) Universal quick docking-station for drymarker-pens

(76) Inventor: Charles M. Conover, Encinitas, CA (US)

Correspondence Address: CHARLES M. CONOVER, 1624 Scott Place, Encinitas, CA, 92024, US

(21) Appl. No.: 09/825,755

(22) Filed: Apr. 5, 2001

(51) Int. Cl. B43K 23/02; B43K 5/00

(52) U.S. Cl. 401/131; 401/202

(57) ABSTRACT

This invention contemplates methods and supporting apparatus by which to facilitate more convenient utilization of conventional commercially available drymarker type pens commonly used by both children and adults, both at home, at school, and by people in various avenues of business, such as for hurried marking of ordered goods with pick-up identification, to making corporate-charts upon whiteboards. The primary notion being to obviate the pesky procedure of fussing with a conventional drymarker's sealing-cap. Among the different generic-variant embodiments set forth, are three ways of implementing the manual gravity-maintained insertion of a capless conventional drymarker-pen into a docking receiver-unit to sealingly prevent ambient-air from diluting the drymarker's internal-ink substance, which are: . . . a.) via adapting the pen's actual original female-cap into a special captive-holder, thereby acting as an anchored receiver; . . . b.) via a conventional type of female/reciever-unit, however provided with integrally-molded hold-down; or, . . . c.) by providing a female/receiver-unit having a critically tapered receptacle sealingly accommodating a pen's nose or the barrel-body. Additional iterations are set forth within these receiver-unit parameters, facilitating the actual fixing of the overall docking-station assembly to various surfaces by different attachment means, as well as exploring varying mounting positions.

### BACKGROUND OF THE INVENTION

1. Field of the Invention

This invention relates to apparatus and methods by which to adaptively provide a mounting for a drymarker type pen;—and more specifically, it relates to such apparatus constituting a manner of docking-station to an existing drymarker-pen for its more convenient accessibility.

2. Relevant Prior-Art

Background research discovery provides some prior patent-art regarded as germane to this disclosure, chronologically for example U.S. Pat. No. 1,704,248(filed: January 1927) shows a portable fountain-pen ink-well for receiving and supporting an old-fashioned quill-pen having a bifurcated-nib,—not a wick type writing-tip. A hollow-tubular entry-funnel neck portion projects upward from a liquid-ink containing base, at an angle or vertically; and, the inner-surface of the neck tapers slightly inwards to limit insertion of the pen, while the entry-funnel has an outward annular-flare facilitating easier targeting of the pen thereto. However, the apparatus is constructed to operate in combination with liquid-ink, and thus would not be suitably adaptable to usage as a drymarker-pen holder, particularly owing that the large internal chamber would bring about air-evaporation of the drymarker's ink-saturated wick member (which must be substantially isolated from air during disuse).

In U.S. Pat. No. 2,297,806(filed: April 1941) is shown a magnetic-holder for pencils/pens or the like, wherein a bifurcated C-clip is employed to hold a writing-pen, while a magnet is secured to a flat external surface portion of the C-clip. The holder and magnet assembly thus stays with the writing-pen, while optional accessory attachments include a spring-clip for mounting to the edge of a writting-tablet or desk-overhang for example; while an alternate optional accessory is a suction-cup for mounting upon various other opportune smooth-surfaces.

In French Pat. No. 2,489,753(filed: September 1980) is shown (FIGS. 4-6) a block having a plurality of female receiving-bores formed to accommodate quick and easy entry stowing of a drymarker-pen tip-barrel portion. The block-body includes several finger-relief holes so as to better enable an artist to passively hold several of the drymarker-pens in one hand, without having to grapple with removing and replacing (nor fumbling with misplacing) the individual stow-caps normally provided with the individual drymarker-pens. However, the device being hand-portable, does not address the notion of a stationary(fixed) universal type of capless drymarker docking-station apparatus.

In U.S. Pat. No 2,650,570(filed: December 1951) is shown an ink-well in which is included a compression—spring which applies an outward—biasing loading against a pen-nib centering-cup; thereby keeping the writing-pen centered as it is fully landed into the cylindrical socket or bore supportive of the landed writing-pen. However, while doing a good job of obviating the nuisance of formerly withdrawing a pen whilst dragging the wet pen-quill across the aperture only to find the grip portion subsequently smeared with the wet ink, hence upon one's gripping-fingers;—the apparatus does not address the problem of needing to simultaneously accommodate several different pen-body diameters.

In U.S. Pat. No. 3,0020,578(filed: December 1960) is shown a combination ink-well and felt-nib pen apparatus, wherein the usual cap is removed from the drymarker-pen and the felt-tip and forward terminus of the drymarker-pen are inserted down into the tubular-bore receptacle of the ink-well;—thereby enabling the drymarker-pen to become replenished via capillary-action. A finger-clip is included for holding the drymarker-pen's cap while this procedure is underway, which may take several hours; at which point it is assumed that the special ink-well also has a cap of some sort for preventing evaporation of the ink contained therein. The fit of the drymarker-pen's forward grip portion does not appear to facilitate any sort of particular diametrical fitting.

In U.S. Pat. No. 3,176,662(filed: July 1962) is shown an illustrator's multi/precision-pen holding desk-set (such as for RipidOgraph, LeRoy, ArtBrown, etc.), which includes a common well containing a wet-reservoir of ink; serving to prevent the on-going problem of the tiny floating-quill becoming dry,—which commonly results in its breakage during attempt at reusing. However, no attempt is indicated to address the problem of facilitating the several different diametrical-sizes of the drymarker-pens presently on the market.

In U.S. Pat No. 4,355,726(filed: August 1980 from Germany) is shown a stand for holding and sealingly retaining a plurality of india-ink type technical-pen instruments; the receiving-socket having a progressively smaller stepped cylindrical-bore as to more intimately fit the specific brand of ink-pen, including an innermost spring-loaded ink-tip impingement-pad by which to seal-off the pen's delicate internals from dreaded ink-evaporation. However, the stepped-funnel configuration of the receiving-socket does not adapt to receiving variously sized grip-portion barrel diameters.

In U.S. Pat. No. 4,493,575(filed: October 1982 from Germany) is shown a protective-holder for an india-ink type technical-pen, but there is no provision intended for sealing-off ambient-air from effecting the pen's tip portion, nor does the stepped-socket receiver contemplate accommodating more than one particular brand of gripping-barrel diameter.

In U.S. Pat. No. 4,548,325(filed: March 1984) is shown a holder for an india-ink type technical-pen, and includes a transverse elastomeric pen-tip occluding member arranged extremely into the receiving-socket; but the stepped-socket configuration is diametrically sized to fit only a single brand of gripping-barrel size.

In U.S. Pat. No. 4,573,818(filed: March 1986 from Japan) is shown a unified plural-cap assembly for receiving three writing-pens, and including a transverse swivel-axis whereby each pen may be pivotally separated from the others; however, there in no contemplation of providing for accommodating more than one diametrically sized socket-bore.

In U.S. Pat. No. 5,033,629(filed: April 1990) is shown a desk-stand for one or more drymarker-pens which contemplates various ways of receiving and holding the nose of a particular brand of drymarker-pen in an airtight manner;—however, the invention does not address the further problem of accomodating more than one type of drymarker-pen in a single receiver-socket configuration.

In U.S. Pat. No. 5,337,906(filed: April 1993) is shown a so called wall-secretary apparatus providing a smorgasbord of features for the convenience of its user, including a pair of siamesed vertical tubular receptacles, each of which having a D-shaped horizontal/cross-section, that are said to provide the a wall-mountable secretary-fixture a quick and easy place for holding of writing-implements (pencil, ballpoint-pen, etc.); however, there is no provision for sealing-off an uncapped drymarker-pen's felt-tip portion.

In U.S. Pat. No. 6,022,159(filed: October 1998) is shown a special unitized dual/dry-marker pen holder apparatus for one's shirt-pocket; however of which, while obviating the need for replacing a loose cap member, owing that the socket chambers are straight-walled cylindrical bores, does not address the need for accommodating more than one type of drymarker-pen nose gripping portion diametrical size.

Therefore, in full consideration of the preceding patent review, there is determined a need for an improved form of device to which these patents have been largely addressed. Accordingly, the instant inventor hereof believes their newly improved drymarker-pen holder device, commercially referred to as the “MarkerDocker™”, currently being developed for production under auspices of Conover-Mfg./Mkt.Co., exhibits certain advantages as shall become revealed in the subsequent portion of this instant disclosure.

### SUMMARY OF THE INVENTION

A.) In view of the foregoing discussion about the earlier invention art, it is therefore important to make it pellucid to others interested in the art that the object of this invention is to provide a drymarker-pen holder which elongated socket like female receptacle portion is specially configured as to more universally accommodate more than just one manufacturer's brand of nose-end barrel terminus portion cross-section diameter. This needed feature lends advantage to the user, by enabling my critically tapered and stepped socket member portion to effectively receive, seat, and atmosphericly isolate the drymarker's felt-tip projection portion, well known to be a problem relative to evaporation of the vaporous vital chemical-solvent substances borne by the wet-ink saturate of the felt-tip or nib portion,—which typically extends entirely into the confines of the drymarker-pen's elongate cylindrical body.

B.) Another object of this invention disclosure is to set forth a drymarker-pen docking-station article obviating requirement for the usual removable cap (generally necessitated as to prevent evaporation of the ink-solvents), and including a base portion providing some manner of fixing the docking-station, whereby the user need only grasp the grip portion of the drymarker-pen and withdraw the implement from its resting or stowed position there within the special socket portion of the docking-station. The notion being, that for places of usage such as for example quick-order businesses and similar other scenarios (rush-order takers at drive-up windows of fast-food establishments, laundry/dry-cleaners, toll-stations, warehouse shipping-dispatchers, quick notations for peace-officers in police-cars, etc.,—the prospective list is lengthy); an improved type of docking-station is desired, facilitating quick and easy docking of various different barrel diametrical sizes found upon modern drymarker-pen implements. For example, the currently popular MARKS-A-LOT®(Mfg. by Avery Corp) has a cylindrical body finger-grip portion measuring a nominal 11/32″-diam., the popular MARKETTE®(Mfg. by Sanford Corp.) has a cylindrical body finger-grip portion measuring a nominal ⅝″-diam., and the popular SHARPIE®(also Mfg. by Sanford Corp.) has a cylindrical body finger-grip-portion measuring a nominal ⅜″-diam.; such variances thus posing a problem at the end user, who may not always be able to obtain the same particular brand of drymarker-pen, so needs a docking-station device which is substantially universal in its ability to accommodate various makes of drymarker-pens.

C.) Another object of this invention disclosure is to set forth a drymarker-pen docking-station article according to preceding items—A & B, wherein a further object of the invention is to provide several different generic-variant and generally integrally-molded mountings by which the drymarker-pen docking-station may be adapted for attachment to different surfaces of various environmental situations. Plus, a universal receiver-mount is optionally set forth, which facilitates anchored mounting of any drymarker-pen's original cap type closure adapted as a rudimentary fixed receiver-cavity portion of the overall docking-station variant embodiment.

### DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the claims section annexed hereto; and accordingly, a better understanding of the invention and the variant uses is intended, by reference to the drawings, which are considered as primarily exemplary and not to be therefore construed as restrictive in nature; wherein:

FIG. 1 is a pictorial perspective-view favoring the upper-right frontal aspect of an exemplified universal fixture, representing the most rudimentary embodiment of this invention disclosure,—configured as to adapt an existing drymarker-pen's original closure-cap to facilitate the receiver-cavity function of the docking-station;

FIG. 2 is a gineric-variant iteration thereof, shown in a partial cross-sectional left-side/elevation-view, revealing an alternate receiver-cavity configuration for accommodating the drymarker-pen's existing sealing-cap;

FIG. 3 is a longitudinal cross-sectional view showing a further gineric-variant embodiment of the drymarker-pen docking-station, wherein is revealed a special stepped and tapered universal drymarker-pen receiver-cavity;

FIG. 4 is also a partial cross-sectional left-side/elevation-view, demonstrating how a particular drymarker-pen is similarly accommodated into the wall mounted receiver-cavity;

FIG. 5 is a pictorial perspective-view favoring the upper-right frontal aspect of an exemplified existing fast-order form hanger-bracket, exemplifying the preferred positioning of a drymarker-pen docking-station according to the instant disclosure hereof.

### ITEMIZED NOMENCLATURE REFERENCES:

10,10′—existing drymarker-nib, nib isolation-chamber

11,11′—existing drymarker tip-support snout, longitudinal-axis of ref.

12,12′/12″—existing drymarker sealing-cap, cap-cavity, docking action ref.-arrow

13—existing drymarker cylindrical body barrel finger grip portion

14—existing planar supporting surface

15—universal cap-support fixture

16,16′—fixed receiver-barrel portion, adjustable receiver-barrel

17,17′—transversely opposed bifurcated radial-tabs, transverse clamping-screw

18,18′—planar mounting-pad, mounting-screw

19′/19″,19—fixed pressure-pad (upper-surface / under-surface), aftward-extension

20,20′—alligator-clamp jaw, finger-squeeze extension

21,21′—alligator-clamp pivot-support, transverse pivot-axis

22—clamping action ref.-arrow

23,23′—universal receiver-barrel, longitudinal-axis

24′,24″—chamfered-entry flair, universal receiver-cavity socket

25′, 25″—outer/tapered-bore, inner/tapered-bore

26′, 26″—transitional-step, inner-occlusion

27—11/32-inch diameter ref-ball indicating seizure point

28—⅝-inch diameter ref.-ball indicating seizure point

29—⅜-inch diameter ref.-ball indicating seizure point

30′/30″,30,30p,30s—ball, socket, screw-threaded post, access-port, phillips-screwdriver

31,31′—annular interference-fit, cap receiver-cavity

32′/32″,32—bilateral support-flanges (left / right), rivet-fasteners

33—double-face adhesive foam-tape

34,34′,34″—thumb-knob, screw-threaded shank, cap locking-tip

35,35′,35″—existing fast-order hanger-bracket, ball-pinch retention-ramp, pinching-point

36,36′,36″—ball-bearing keeper, order-form, pull-of-gravity action ref.-arrow

### DETAILED DESCRIPTION OF THE PREFERRED EMBODIMENTS

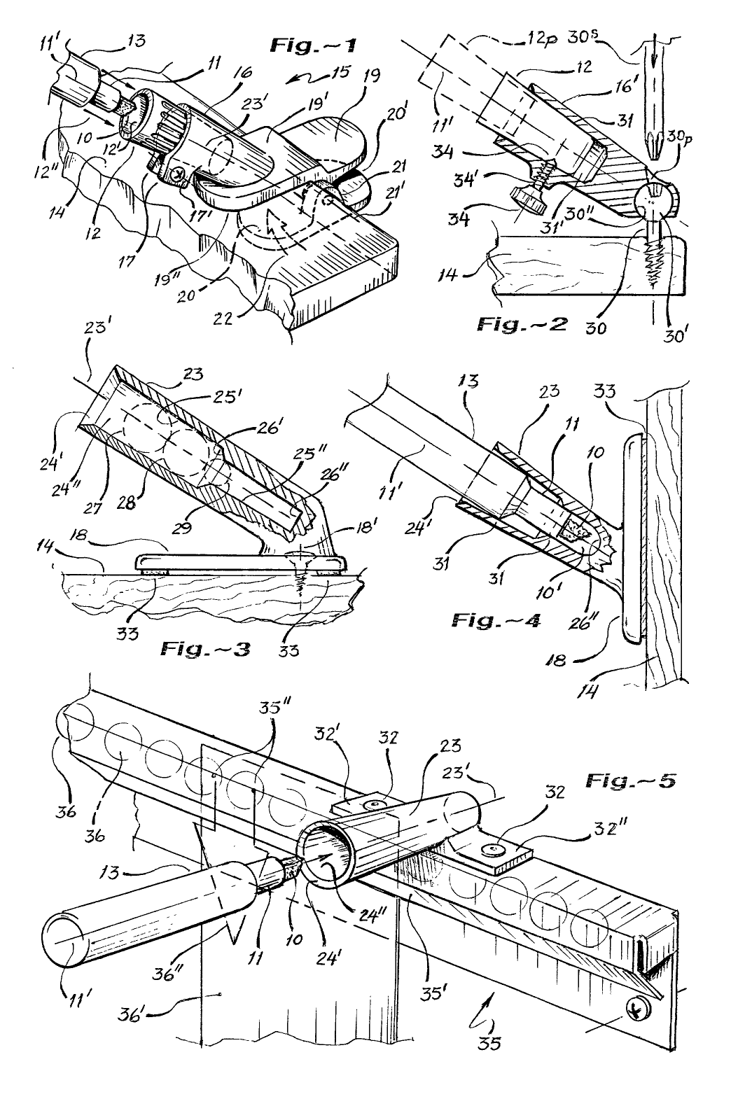

initial reference is given by way of FIG. 1, wherein is exhibited a universal drymarker-cap mounting fixture 15 version of my invention disclosure, which defines docking-station for landing for a drymarker-pen, and embodies a hand-operated clamp for quick and easy mounting upon most any platform surface, such as the exemplified existing planar desk edge 14. This fixture employs an exemplified fixed receiver-barrel portion 16 serving to receive most any existing drymarker-pen sealing-cap 12 within the cap receiver-cavity (see FIG. 2) formed by the substantially encircling wall of the receiver-barrel 16 shown integrally molded with the forward fixed pressure-pad 19′ having planar under-surface 19″. The mounting portion is further Joined with an integral tab like aftward-extension 19 to which is pivoetally coupled a thumb and finger operated alligator-clamp law like member 20 having pivot-support 21 and pivot-axis 21′ in cooperation with a axially-coiled clamping-action spring (not shown here); thereby facilitating opening of the jaw portion via integral finger-squeeze tab like extension 21′. In both FIGS. 1 & 2, the existing exemplified EM,original equipment manufacture) sealing-cap 12 (note unseated phantom-outline 12p) is thus initially inserted into the cap receiver-cavity preferably until it becomes frictionally seated 12, at which point the sealing-cap is made more securely anchored therein via either tightening of the transverse clamping-screw 17′, which draws the opposed tab like bifurcated clamping-ears 17 closer together in a cinching action around the sealing-cap 12;—or alternately, via a staking action accomplished by simply turning of the thumb-screw 34 having a positively impinging locking-tip 34″.

Also shown in FIG. 2 is an optional ball-&-socket mounting arrangement, wherein a conventional philips type screwdriver can preferably be inserted into the mating X-relief formed within the spherical-head of ball portion 30′ via access-port 30p, as to thereby drive the screw-threaded stanchion like post 30 securely into the exemplified planar platform supporting surface 14. The molded-plastic socket portion 30″ is formed as to be a tight fit around the ball 30′, thereby enabling the thus repositionable receiver-barrel 16′ to be oriented to any desired pitch-angle, for convenient targeting by the drymarker-pen's snout 11.

There remain subtle, however vital other differences which are to become herein more evident and understood as important improvements. For example, reference to FIGS. 3 and 4 shows an alternate embodiment of the invention disclosure, wherein instead of utilizing the OEM sealing-cap, a special critically tapered and stepped universal receiver-cavity 24″ is provided. Note in FIG. 3 that in order to more clearly demonstrate how the special elongate socket like receiver-cavity functions relative to accommodating different models of drymarker-pens, a triad of phantom balls are shown to be detained therein, where for example a ball-bearing of 11/32-inch diameter would diametrically impinge and be fully seated at stage 27;—a ball-bearing of ⅝-inch diameter would diametrically impinge and be fully gravity seated at stage 28; and. -a ball-bearing of ⅜-inch diameter would be seated at innermost stage 29. Accordingly, FIG. 4 further demonstrates how this critical insertion staging appears as a like annular interference-fit at points 31. Note also, how the innermost seating of the drymarker-pen's snout 11 at point 31, made self-centering during seating by provision of the preferably 45-degree taper of transitional-stem 26′(ref.-FIG. 3), creates an intimately occluded 26″ nib isolation-chamber 10′;—which air-tightness prevents solvent evaporation of the inked-wick (passing into the drymarker's barrel) nib.

Note also in FIGS. 3 & 4, how the planar mounting-pad 18 is preferably integrally formed with the universal receiving-barrel 23; the primary difference being that these exemplified docking-stations are shown as a horizontal mounting in FIG. 3 and as a vertical mounting in FIG. 4. Also, in FIG. 3 a choice of mounting-screws 18′ or localized double-faced adhesive foam-tape 33 is offered; while in FIG. 4 just a large full-area mounting of double-faced adhesive foam-tape 33 is exemplified.

Finally, in FIG. 5 an alternate universal receiver-barrel 23 having longitudinal-axis 23′ is shown replete with bilateral support-flanges 32′ and 32″ formed integral with the receiver-barrel 23; and may be secured in place via pop-rivets 32 upon an exemplified existing hanger-bracket 35, which is of the type (such as mfg.& mkt'd by the Ex-cell Metal-products Co. of Franklin Park, Ill. 60131) commonly found in fast-order establishments. These handy hanger-brackets are generally of extruded aluminum, and are formed with end-tab occlusions as to contain a linear horizontal plurality of marbles 36, which act upon the ramp like surface 35′ to create a resulting pinching-point action upon any manually inserted fast-order form 36′ along exemplified points 35″. Thus in operation, the drive-up window order taking person can now quickly pull the conventional drymarker-pen 13 from the provisional docking-station offered by the universal receiver-barrel 23, quickly jot down the drive-through customer's order, and target the universal receiver-cavity 24″ with centering assistance afforded by presence of chamfered-entry flair 24′; while shoving the order-form 36′ into place where it can likewise be readily pulled down for acting upon by kitchen workers. Hence, a seemingly to some perhaps mundane routine task, is now made more efficient, owing to the valued combination of cooperating apparatus;—making for what an evaluating Manager/efficiency-expert of a chain of Mexican/fast-food shops considers an important improvement to the business's daily procedure.

Thus, it is readily understood how the preferred and generic-variant embodiments of this invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is

What is claimed of proprietary inventive origin is:

1. A universal docking-station for drymarker-pens, facilitating a more convenient usage obviating usual manual cap-closure replacement procedure, said apparatus comprising:
a receiver-barrel having a socket like receiver-cavity defining a variable sizing means by which to intimately accept two or more differently sized conventional commercially available drymarker-pen barrel nose portions without need for diametrical readjustment to fit a specific drymarker-pen grip portion diameter, hence enabling single handed operation obviating need for usual manual removal and replacement of a sealing-cap thereto; and, including a fixed mounting means provided thereto.

2. The universal docking-station apparatus according to claim 1, wherein said receiver-cavity is configured internally with a diametrically tapered and stepped formation thereby accommodating more than one brand of commercially available drymarker-pen in an air-tight manner.

3. The universal docking-station apparatus according to claim 2, wherein the gripping portion of a drymarker-pen is supported within said tapered portion while the drymarker-pen's snout is supported discretely within said said stepped portion; thereby confining the nib portion of said drymarker-pen within a dedicated cavity for minimal evaporative degradation of the nib's solvents.

4. The universal docking-station apparatus according to claim 1, wherein said receiver-cavity is formed with a progressively tapering proximal entrance diameter of about 11/32-inch narrowing inward to about ⅝-inch diameter then stepping down to only about ⅜-inch diameter, whereby more than one manufacturer's brand of drymarker-pen can be received in an air-tight manner.

5. The universal docking-station apparatus according to claim 1, wherein said receiver-cavity is configured with an internal diametrically tapering formation which is approximately 1-degree to 2-degrees relative to the longitudinal-axis of said receiver-cavity; whereby more than one manufacturer's brand of drymarker-pen can be received in an air-tight manner.

6. The universal docking-station apparatus according to claim 1, wherein said receiver-cavity portion has an entry flair annulation of approximately 30-45 degrees chamfer; thereby aiding the manual targeting of the receptacle.

7. The universal docking-station apparatus according to claim 1, wherein said fixed mounting means is a rigid mounting-pad having a planar mounting-surface side and at least one screw-hole passing at a right-angle through the top and bottom of the mounting-pad; whereby a conventional screw can be inserted there through for screwing the mounting-pad to a horizontal, inclined, or vertical supporting surface.

8. The universal docking-station apparatus according to claim 1, wherein said fixed mounting means is via a pair of rigid planar bilateral support-flanges extending from opposite sides of said receiver-barrel portion.

9. The universal docking-station apparatus according to claim 1, wherein said fixed mounting means is a screw-threaded post formed with an integral ball portion sized to fit tightly into a socket portion formed into the aftward end of said receiver-barrel portion; thereby enabling reorienting of said receiver-barrel to an attitude preferred by the user of said drymarker-pen.

10. The universal docking-station apparatus according to claim 1, wherein said fixed mounting means is via an integrally formed pressure-pad member having a planar a under-surface and an aftward-extension thereto having a downward portion supporting a transverse pivot-axis upon which is supported an alligator-clamp like clamping jaw member; thereby facilitating manual attachment upon an existing planar supporting surface.

11. The universal docking-station apparatus according to claim 1, wherein said fixed mounting means is a contegiously formed planar mounting-pad the underside of which is provided with a double-faced foam adhesive tape having a removable protective substrate for permanent mounting of said mounting-pad upon a horizontal, inclined, or vertical supporting surface.

12. A universal docking-station for drymarker-pens, facilitating a more convenient usage obviating usual manual cap-closure replacement procedure, said apparatus comprising:
a receiver-barrel having a socket like receiver-cavity and holding means thereto capable of retaining the existing sealing-cap of a conventional commercially available drymarker-pen, thereby enabling the drymarker-pen to be intimately seated single handedly into its original sealing-cap while obviating need for repeated removal and replacement by its user; and, including a fixed mounting means provided thereto.

13. The universal docking-station apparatus according to claim 12, wherein said sealing-cap holding means is provided by an integral clamp comprising a bifurcated radial-tab arrangement extending outwardly from said receiver-barrel, and including a longitudinal relief-slot separating said radial-tabs; plus, a transverse clamping-screw or equivalent screw-threaded adjustment means extending between said radial-tabs as to impose a tight gripping action about the circumference of a sealing-cap.

14. The universal docking-station apparatus according to claim 12, wherein said sealing-cap holding means is provided by a thumb-screw extending radially outwardly from said receiver-barrel as to enable user to manually rotate said thumb-screw and thereby impose a retentive piercing of the thumb-screw locking-tip into the sidewall of a sealing-cap.

15. The universal docking-station apparatus according to claim 12, wherein said fixed mounting means is a rigid mounting-pad having a planar mounting-surface side and at least one screw-hole passing at a right-angle through the top and bottom of the mounting-pad; whereby a conventional screw can be inserted there through for screwing the mounting-pad to a horizontal, inclined, or vertical supporting surface.

16. The universal docking-station apparatus according to claim 12, wherein said fixed mounting means is via a pair of rigid planar bilateral support-flanges extending from opposite sides of said receiver-barrel portion.

17. The universal docking-station apparatus according to claim 12, wherein said fixed mounting means is a screw-threaded post formed with an integral ball portion sized to fit tightly into a socket portion formed into the aftward end of said receiver-barrel portion; thereby enabling reorienting of said receiver-barrel to an attitude preferred by the user of said drymarker-pen.

18. The universal docking-station apparatus according to claim 12, wherein said fixed mounting means is via an integrally formed pressure-pad member having a planar under-surface and an aftward-extension thereto having a downward portion supporting a transverse pivot-axis upon which is supported an alligator-clamp like clamping jaw member; thereby facilitating manual attachment upon an existing planar supporting surface.

19. The universal docking-station apparatus according to claim 12, wherein said fixed mounting means is a contagiously formed planar mounting-pad the underside of which is provided with a double-faced foam adhesive tape having a removable protective substrate for permanent mounting of said mounting-pad upon a horizontal, inclined, or vertical supporting surface.

20. A method by which to provide a universal docking-station for drymarker-pens, facilitating a more convenient usage obviating usual manual cap-closure replacement procedure, said method comprising:
providing a receiver-barrel having a socket like receiver-cavity capable of accepting the existing sealing-cap of a conventional commercially available drymarker-pen;
inserting the conventional sealing-cap member into the receiver-cavity, and securing the sealing-cap therein via a circumferential gripping action means or via a transverse staking device means;
thereby enabling said drymarker-pen to be intimately seated single handedly into its original sealing-cap while obviating need for repeated removal and replacement by its user in cooperation with a fixed mounting means provided thereto.
